(19) United States
(12) Patent Application Publication
(10) Pub. No.: US 2009/0301863 A1
(43) Pub. Date: Dec. 10, 2009

(54) METHOD AND APPARATUS FOR DUST SUPRESSION

(75) Inventors: Wallace Swanson, JR., Marina, CA (US); Dewayne W. Browning, Paradise, CA (US); Anthony Wayne Ringeisen, Ripon, CA (US)

Correspondence Address: DAVIS WRIGHT TREMAINE LLP/Los Angeles, 865 FIGUEROA STREET, SUITE 2400, LOS ANGELES, CA, 90017-2566, US

(73) Assignee: ORCHARD EQUIPMENT MANUFACTURING, LLC, Turlock, CA (US)

(21) Appl. No.: 12/134,506

(22) Filed: Jun. 6, 2008

(51) Int. Cl. B01J 19/08

(52) U.S. Cl. 204/164; 422/129

(57) ABSTRACT

The subject matter relates to devices and methods for dust suppression utilizing an electrostatic dust suppression apparatus which develops an ion cloud containing charged particles for attracting or charging floating dust by bonding to the dust molecules. The particle are introduced through an electrode of the electrostatic dust suppression apparatus which adds an electrostatic charge to the particles as they are dispersed onto an area of fugitive dust. The disbursement of the electrostatic charged particles is accomplished by a pressurized air stream. The electrostatically charged particles attract the fugitive dust and cause the formation of large agglomerates that gravitationally fall to the earth or are electrostatically attracted to the earth.

### FIELD OF THE SUBJECT MATTER

The present subject matter relates to methods and apparatus for dust suppression in agricultural settings incorporating the use of electrostatically charged particles.

### BACKGROUND OF THE SUBJECT MATTER

All publications herein are incorporated by reference to the same extent as if each individual publication or patent application was specifically and individually indicated to be incorporated by reference. The following description includes information that may be useful in understanding the present subject matter. It is not an admission that any of the information provided herein is prior art or relevant to the presently claimed subject matter, or that any publication specifically or implicitly referenced is prior art.

During a variety of farming activities fugitive dust is generated by equipment and machinery which may be used in the collection of crops, preparation of the soil, or application of pesticides or minerals for soil improvement. The fugitive dust generated leads to decreased air quality, unhealthy work conditions, increased wear and tear on farming machinery, and frustrates community relations. In addition, unclear air conditions decrease productivity in workers and in farm vehicles due to impaired vision caused by fugitive dust.

Current methods for controlling fugitive dust include using chemical stabilization products or water sprays from tank trucks. Chemical stabilization products can be sprayed onto the dusty surface, or mixed into the soil at weekly or monthly intervals. Traditional products used for dust control and soil stabilization consist of used or recycled oil, virgin oils, chlorides, lignins, and emulsifications made with low-grade petroleum resins, asphalt, oil, and pitch.

However, in recent years heightened awareness of environmental, health and safety issues associated with chemical stabilization products has spawned the need for alternative, safer methods for controlling dust, and has given rise to legislation in most states curtailing the use of these products for dust control. Additionally, chemical stabilization products have limited value as dust suppressants as they act as particle weighting agents, by the process of adsorption, and do not have any significant cohesive action for soil stabilization and control of fine dust.

Furthermore, the use of chemical stabilization products is disadvantageous and costly because it often requires repeat application, and the chemical constituents interfere with soil quality and may encourage pollutants in the soil, which migrate to and may contaminate the end product.

An alternative method for dust suppression incorporates water sprays for controlling fugitive dust. Water sprays are typically performed by water trucks that have been adapted with large volume tanks and a spray distribution system attached to the front or rear of the truck's body. These water trucks travel the farmland spraying water at regular time intervals. While water truck spraying is easy to apply and readily available, it is also disadvantageous because the dust control only lasts a short duration of time and the use of extra water in an effort to increase dust suppression tends to cause slippery conditions which may interfere with farming equipment and over hydrate the soil. Furthermore, the use of water trucks may be impractical in narrow or sloping regions, typical in farming applications, and may lead to erosion and degradation of minerals in the soil on inclined farmland. Moreover, the practice can be costly due to the necessity to purchase, maintain and operate a water truck.

Due to the disadvantages associated with the current methods and apparatus for dust suppression, namely, chemical stabilization or water spraying, there exists a need for a dust suppression system or device for controlling fugitive dust generated in agricultural activities, that is cost efficient, effective over long durations of time, and safe for the environment.

### DESCRIPTION OF THE FIGURES

Exemplary embodiments are illustrated in referenced figures and tables. It is intended that the embodiments, figures and tables disclosed herein are to be considered illustrative rather than restrictive. The dimensions shown in various figures are in millimeters.

FIG. 1. A side perspective view of the dust suppression apparatus.

FIG. 2A. A bottom perspective view of the dust suppression apparatus taken from the discharge tube end.

FIG. 2B. A side perspective view of the dust suppression apparatus.

### DETAILED DESCRIPTION OF THE SUBJECT MATTER

All references cited herein are incorporated by reference in their entirety as though fully set forth. One skilled in the art will recognize many methods, apparatus and materials similar or equivalent to those described herein, which could be used in the practice of the present subject matter. Indeed, the present subject matter is in no way limited to the methods, apparatus and materials described.

The present subject matter addresses the disadvantages of prior methods and apparatus for controlling dust produced by the collection of crops, preparation of soil, or application of pesticides, minerals for soil improvement, and other general agricultural activities, by introducing a method and apparatus for applying electrostatically charged particles onto fugitive dust prior to or while conducting farming activities which may generate fugitive dust.

The subject matter describes devices and methods for dust suppression utilizing an electrostatic dust suppression apparatus which develops an ion cloud containing charged particles for attracting or charging floating dust by bonding to the dust molecules. The particles are introduced to the electrode of the electrostatic dust suppression apparatus which adds an electrostatic charge to the particles as the particles are being dispersed onto an area of fugitive dust. The disbursement of the electrostatic charged particles is accomplished by a pressurized particle stream. The electrostatically charged particles attract or charge the fugitive dust and cause the formation of large agglomerates that may gravitationally fall to the earth or may be electrostatically attracted to the earth, thus suppressing dust.

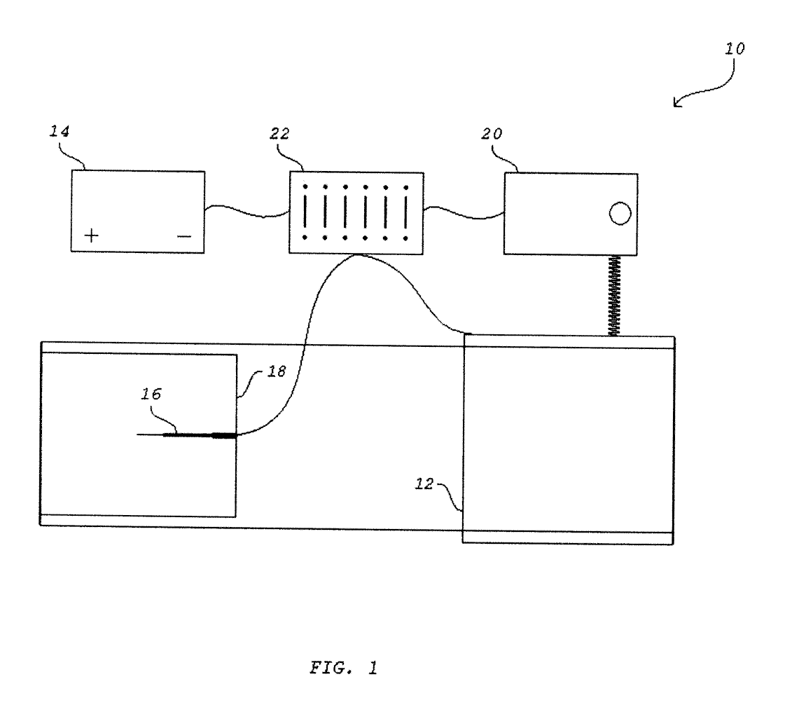

Referring now to the drawings in which like parts are designated by like reference characters throughout the several views. FIG. 1 shows one embodiment of the dust suppression system according to the subject matter, in which the dust suppression apparatus 10 contains a pressurized air supply unit 12, a power supply 14, an electrode 16, and a discharge tube 18. The power supply 14 provides power to the pressurized air supply unit 12 and electrode 16 for operation of the dust suppression apparatus 10. The electrode 16 may be needle point or sharp tipped allowing for a higher ionic gradient for facilitation of the electrostatic charge. Preferably, the apparatus also includes a charge air system 20 which is operationally connected to the pressurized air supply unit 12, thus ensuring adequate pressurization of the dust suppression apparatus 10. A control panel 22 is optimally connected to the dust suppression apparatus 10 to provide for both manual and automated activation of the dust suppression apparatus 10. All elements of the dust suppression apparatus are connected by an appropriately placed network of electrical wiring, pipes, hoses, and valves.

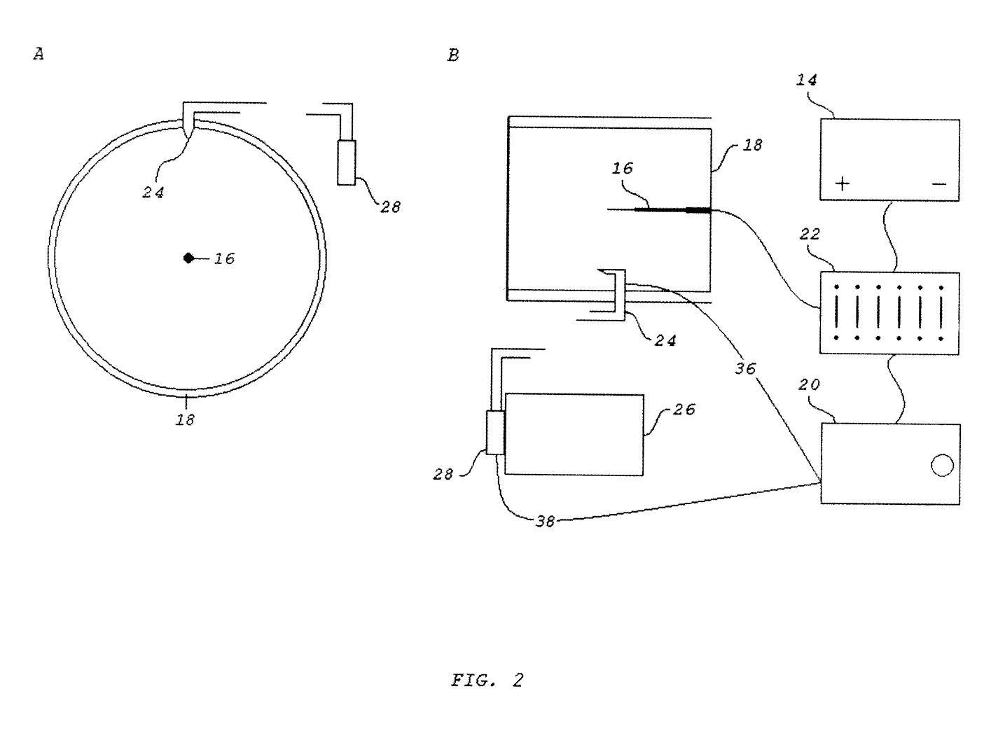

Alternatively, as seen in FIG. 2A and FIG. 2B, the dust suppression apparatus may contain at least one particle emitter 24 in the discharge tube 18 for introduction of particles for ionization by the electrode 16. In addition, as depicted in FIG. 2B, a particle supply 26 may be operationally connected to the particle emitters 24 for delivery of the particles to the discharge tube 18. Preferably the particle supply 26 comprises one or more tanks comprising water or other charge accepting compounds that can be electrostatically charged to carry an appropriate charge sufficient to suppress fugitive dust. Secondary additives such as soaps, detergents or other like components may also be utilized to increase the dust suppression efficiencies of the charged particles, improve moisture content, reduce freezing or clogging of the charged particles, or otherwise improve upon the effective use of the dust suppression apparatus.

With reference to FIG. 2B, a pump 28 is suitably connected via appropriate plumbing to the particle supply 26. The pump 28 is further attached to the particle emitter 24 found in the discharge tube 18 for transferring of particles from the particle supply 26 to the particle emitter 24. In accordance with a preferred aspect of the present subject matter, the particle emitter 24 is capable of varying the emittence rate or polarity, preferably managed by the control panel 22. The particles provided by the particle emitter 24 are electrostatically charged by the electrode 16 by a high voltage gradient through the corona effect. The electrostatically charged particles are then propelled by the pressurized air supply unit 12 through the discharge tube 18 onto an area of fugitive dust. Introduction of the electrostatically charged particles to the fugitive dust promotes bonding creating large agglomerate particles which precipitates from the ion cloud and fall to the earth or may be electrostatically attracted to the earth.

Alternatively, with reference to FIG. 2B, compressed air may be supplied by the charge air system 20 to the particle supply 26 for transfer of the particles from the particle supply 26 to the particle emitter 24 for ionization of the particles by the electrode 16 in the discharge tube 18. Appropriate plumbing operationally connects the air supply system 20 to the particle supply 26 and to the particle emitter 24.

Alternatively, the pressurized air supply unit 12, particle emitter 24 and/or pump 28 may be suitably configured to receive compressed air from a pneumatic system which could be available independent of the apparatus or easily fitted to the apparatus (not shown).

The charge air system 20 may be powered, by the power supply 14, through an outside power source, or from a secondary power source (not shown), such as an engine, which may be mounted to the dust suppression apparatus 10.

A suitable control panel 22 may be implemented to the dust suppression apparatus 10 to monitor, detect and/or control the function of the components of the dust suppression apparatus 10. Referring now to FIG. 1, the control panel 22 advantageously comprises a microprocessor based control unit suitably connected to send signals to and receives signal from multiple components of the dust suppression apparatus 10, including but not limited to, the pressurized air supply unit 12, the power supply 14, the electrode 16, the charge air system 20, the particle emitter 24 (shown in FIG. 2B), the particle supply 26 (shown in FIG. 2B), and pump 28 (shown in FIG. 2B). Commands may be programmed into the control panel 22 by conventional means, for operation of the dust suppression apparatus 10. Functions controlled by the control panel 22 may include, but are not limited to: flow through the particle emitter 24; level of power provided to the electrode 16; and the rate of the pressurized air supply unit 12.

It will be obvious to those skilled in the art that control panel 22 could be programmed to adjust the components of the dust suppression apparatus 10 in a variety of different combinations and based on inputs pertinent to the necessary flow of dust suppression particles.

Various embodiments of the subject matter are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s). Furthermore, no limitations are intended to the details of construction or design herein shown other than as described in the claims below. It is, therefore, evident that the particular embodiments disclosed above may be altered or modified and all such variations are considered within the scope and spirit of the subject matter. Accordingly, the protection sought herein is as set forth in the claims below.

What is claimed is:

1. An apparatus for dust suppression, comprising:
a pressurized air supply unit;
an electrode for charging particles;
a discharge tube for reaction and expulsion of charged particles; and
a power supply for providing energy to the pressurized air supply unit and the electrode,
wherein the apparatus is configured such that, in operation, the pressurized air supply unit delivers particles to the discharge tube, containing the electrode, for ionization of the particles and expulsion of the charged particles to areas of fugitive dust for dust suppression.

2. The apparatus according to claim 1, wherein the power supply is selected from the group consisting of a generator, a DC power source, and an AC power source.

3. The apparatus according to claim 1, further comprising a control panel affixed to the apparatus for operation of the apparatus.

4. The apparatus according to claim 3, wherein the control panel is operationally connected to power supply for providing energy to operate the control panel.

5. The apparatus according to claim 1, further comprising a charge air system operationally attached to the apparatus for providing pressurized air.

6. The apparatus according to claim 1, further comprising a particle supply for storing particles destined for ionization.

7. The apparatus according to claim 6, further comprising a particle emitter connected to the discharge tube for introducing the particles destined for ionization to the electrode.

8. The apparatus according to claim 7, further comprising a pump operationally connected to the particle supply and particle emitter, for transferring particles destined for ionization from the particle supply through the particle emitter to the discharge tube.

9. The apparatus according to claim 8, wherein the pump is operationally connected to the power supply for providing energy to operate the pump.

10. The apparatus according to claim 8, wherein the pump is operationally connected to the charge air system for providing pressurized air to operate the pump

11. The apparatus according to claim 6, wherein the particles destined for ionization are selected from the group consisting of water, dust, air, anion and cation.

12. An apparatus for dust suppression, comprising:
a particle supply unit;
an electrode for charging particles;
a discharge tube for reaction and expulsion of charged particles;
a particle emitter attached to the discharge tube for introducing particles; and
a power supply for providing energy to the pressurized air supply unit and the electrode,
wherein the apparatus is configured such that, in operation, the particle emitter delivers particles from the particle supply unit to the discharge tube, containing the electrode, for ionization of the particles and expulsion of the charged particles to areas of fugitive dust for dust suppression.

13. The apparatus according to claim 12, wherein the particles are selected from the group consisting of water, dust, air, anion and cation.

14. The apparatus according to claim 12, wherein the power supply is selected from the group consisting of a generator, a DC power source, and an AC power source.

15. The apparatus according to claim 12, further comprising a control panel affixed to the apparatus for operation of the apparatus.

16. The apparatus according to claim 15, wherein the control panel is operationally connected to power supply for providing energy to operate the control panel.

17. The apparatus according to claim 12, further comprising a pump operationally connected to the particle supply and particle emitter, for transferring particles from the particle supply through the particle emitter to the discharge tube.

18. The apparatus according to claim 17, wherein the pump is operationally connected to power supply for providing energy to operate the pump.

19. The apparatus according to claim 17, further comprising a charge air system operationally attached to the pump for providing pressurized air to operate the pump.

20. A method of reducing dust, comprising:
providing an apparatus, comprising
a pressurized air supply unit;
an electrode for charging particles;
a discharge tube for reaction and expulsion of charged particles; and
a power supply for providing energy to the pressurized air supply unit and the electrode,
wherein the apparatus is configured such that, in operation, the pressurized air supply unit delivers particles to the discharge tube, containing the electrode, for ionization of the particles and expulsion of the charged particles; and
applying the charged particles to areas of fugitive dust for dust suppression.

21. The method of claim 20, wherein the apparatus further comprises a control panel affixed to the apparatus for operation of the apparatus.

22. The method of claim 20, wherein the charged particles bond with the fugitive dust and create large agglomerate particles which descend to the earth.

23. The method of claim 20, wherein the charged particles bond with the fugitive dust and are electrostatically attracted to the earth.

24. A method of reducing dust, comprising:
providing an apparatus, comprising
a particle supply unit;
an electrode for charging particles;
a discharge tube for reaction and expulsion of charged particles;
a particle emitter attached to the discharge tube for introducing particles; and
a power supply for providing energy to the pressurized air supply unit and the electrode,
wherein the apparatus is configured such that, in operation, the particle emitter delivers particles from the particle supply unit to the discharge tube, containing the electrode, for ionization of the particles and expulsion of the charged particles; and
applying the ionized particles to areas of fugitive dust for dust suppression.

25. The method of claim 24, wherein the apparatus further comprises a control panel affixed to the apparatus for operation of the apparatus.

26. The method of claim 24, wherein the apparatus further comprises a pump operationally connected to the particle supply and particle emitter, for transferring particles from the particle supply through the particle emitter to the discharge tube.

27. The method of claim 24, wherein the particles are selected from the group consisting of water, dust, air, anion and cation.

28. The method of claim 24, wherein the ionized particles bond with the fugitive dust and create large agglomerate particles which descend to the earth.

29. The method of claim 24, wherein the ionized particles bond with the fugitive dust and are electrostatically attracted to the earth.
